(19) United States
(12) Patent Application Publication
(10) Pub. No.: US 2013/0100101 A1
(43) Pub. Date: Apr. 25, 2013

(54) DISPLAY DEVICE, PARALLAX BARRIER, AND DRIVING METHODS FOR 3D DISPLAY

(71) Applicants: Ra-Bin LI, Tainan (TW); Mu-Kai Kang, Pingtung (TW); Heng-Cheng Tseng, Chiayi (TW)

(72) Inventors: Ra-Bin LI, Tainan (TW); Mu-Kai Kang, Pingtung (TW); Heng-Cheng Tseng, Chiayi (TW)

(21) Appl. No.: 13/404,786

(22) Filed: Feb. 24, 2012

(30) Foreign Application Priority Data
Oct. 25, 2011 (TW) 100138669

(51) Int. Cl. G09G 5/00; G02F 1/1335; G02F 1/1333

(52) U.S. Cl. 345/211; 349/138; 349/15

(57) ABSTRACT

A parallax barrier for 3D display is provided. The parallax barrier includes barrier cells which are disposed successively. Each barrier cell includes first and second substrates, a liquid crystal layer, first and second insulation layers, and first and second conductive layers. The first and second substrates are disposed oppositely. The liquid crystal layer is disposed between the first and second substrates. The first and second conductive layers are disposed on the first and second substrates respectively. The second insulation layer and the first insulation layer are disposed on the second conductive layer in order. The first electrode layer is disposed between the liquid crystal layer and the second insulation layer and is electrically isolated from the second conductive layer. The second electrode layer is disposed between the liquid crystal layer and the second insulation layer and is electrically isolated from the second conductive layer.

### CROSS REFERENCE TO RELATED APPLICATIONS

This Application claims priority of Taiwan Patent Application No. 100138669, filed on Oct. 25, 2011, the entirety of which is incorporated by reference herein.

### BACKGROUND OF THE INVENTION

1. Field of the Invention

The invention relates to a 3D display device, and more particularly to a parallax barrier for a 3D display in which two sets of electrodes of a light barrier are disposed on the same substrate, thereby reducing an image crosstalk ratio.

2. Description of the Related Art

FIG. 1 shows a conventional parallax barrier. Generally, a parallax barrier comprises a plurality of barrier cells disposed successively. For clear description, FIG. 1 shows only four barrier cells U11˜U14. In the following, the barrier cell U11 is given as an example for describing a structure of a barrier cell. The other barrier cells U12˜U14 have the same structure of the barrier cell U11. Referring to FIG. 1, substrates SUB11 and SUB12 are disposed oppositely. A liquid crystal layer LC11 is disposed between the substrates SUB11 and SUB12. A conductive layer CL11, an insulation layer IL11, and an electrode layer EL11 are disposed on the substrate SUB11 in order and disposed between the substrate SUB11 and the liquid crystal layer LC11. A conductive layer CL12, an insulation layer IL12, and an electrode layer EL12 are disposed on the substrate SUB12 in order and disposed between the substrates SUB11 and SUB12. In detail, the conductive layer CL12, the insulation layer IL12, and the electrode layer EL12 are disposed between the substrate SUB12 and the liquid crystal layer LC11. According to the structure of FIG. 1, the electrode layers EL11 and EL12 forming a light barrier are disposed on the substrates SUB11 and SUB12 respectively. However, during the process of manufacturing the parallax barriers, since the electrode layers EL11 and EL12 are disposed on the substrates SUB11 and SUB12 respectively, an alignment deviation between the electrode layers EL11 and EL12 may occur due to misalignment between the substrates SUB11 and SUB12. When a parallax barrier with an alignment deviation operates in coordination with a display device to display 3D images, the quality of the displayed images is lowered.

Thus, it is desired to provide a parallax barrier in which electrode layers are disposed on the same substrate. When the parallax barrier operates in coordination with a display device to display 3D images, the quality of the displayed images is enhanced.

### BRIEF SUMMARY OF THE INVENTION

An exemplary embodiment of a parallax barrier for 3D display is provided. The parallax barrier comprises a plurality of barrier cells which are disposed successively. Each of the plurality of barrier cells comprises a first substrate, a second substrate, a liquid crystal layer, a first insulation layer, a second insulation layer, a first conductive layer, and a second conductive layer. The first substrate and the second substrate are disposed oppositely. The liquid crystal layer is disposed between the first substrate and the second substrate. The first conductive layer is disposed on the first substrate. The second conductive layer is disposed on the second substrate. The second insulation layer and the first insulation layer are disposed on the second conductive layer in order. The first electrode layer is disposed between the liquid crystal layer and the second insulation layer and is electrically isolated from the second conductive layer. The second electrode layer is disposed between the liquid crystal layer and the second insulation layer and is electrically isolated from the second conductive layer.

An exemplary embodiment of a driving method for 3D display for driving the above parallax barrier is provided. The driving method comprises providing a common voltage signal and a first voltage signal respectively to the first conductive layer and the second conductive layer. The driving method also comprises providing a second voltage signal and a third voltage signal respectively to the first electrode layer and the second electrode layer. The driving method further comprises successively switching a level of the second voltage signal and a level of the third voltage signal to be equal to a level of the common voltage signal for forming active parallax barrier for 3D display.

An exemplary embodiment of a display device for 3D display for displaying images during a plurality of successive frame periods is provided. The display device comprises a display array, a backlight module, and a parallax barrier. The backlight module is disposed on one side of the display array The parallax barrier is disposed on the other side of the display array. The parallax barrier comprises a plurality of barrier cells disposed successively, and each of the plurality of barrier cells comprises a first substrate, a second substrate, a liquid crystal layer, a first conductive layer, and a second conductive layer. The first substrate and the second substrate are disposed oppositely. The liquid crystal layer is disposed between the first substrate and the second substrate. The first conductive layer is disposed on the first substrate and receives a common voltage signal. The second conductive layer is disposed on the second substrate and receives a first voltage signal. The first electrode layer is disposed between the liquid crystal layer and the second conductive layer and is electrically isolated from the second conductive layer. The first electrode layer receives a second voltage signal. The second electrode layer is disposed between the liquid crystal layer and the second conductive layer and is electrically isolated from the second conductive layer. The second electrode layer receives a third voltage signal. With the plurality of successive frame periods, a level of the second voltage signal and a level of the third voltage signal are equal to a level of the common voltage signal successively.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional parallax barrier;

FIG. 2 is a cross section of one exemplary embodiment of a parallax barrier for 3D display;

FIG. 3 is a cross section of another exemplary embodiment of a parallax barrier for 3D display;

FIG. 4 is a schematic view showing a position relationship between two electrode layers;

FIG. 5 shows an exemplary embodiment of a display device;

FIG. 6 is a schematic view showing a display array of FIG. 5; and

FIG. 7 is a timing chart of main signals of the display device of FIG. 5.

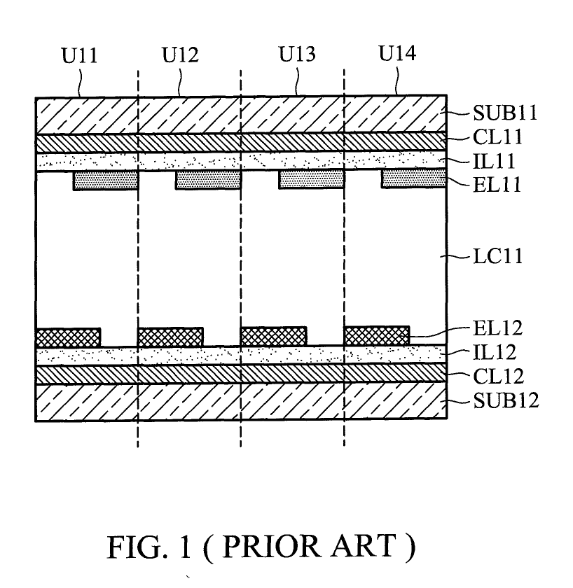

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

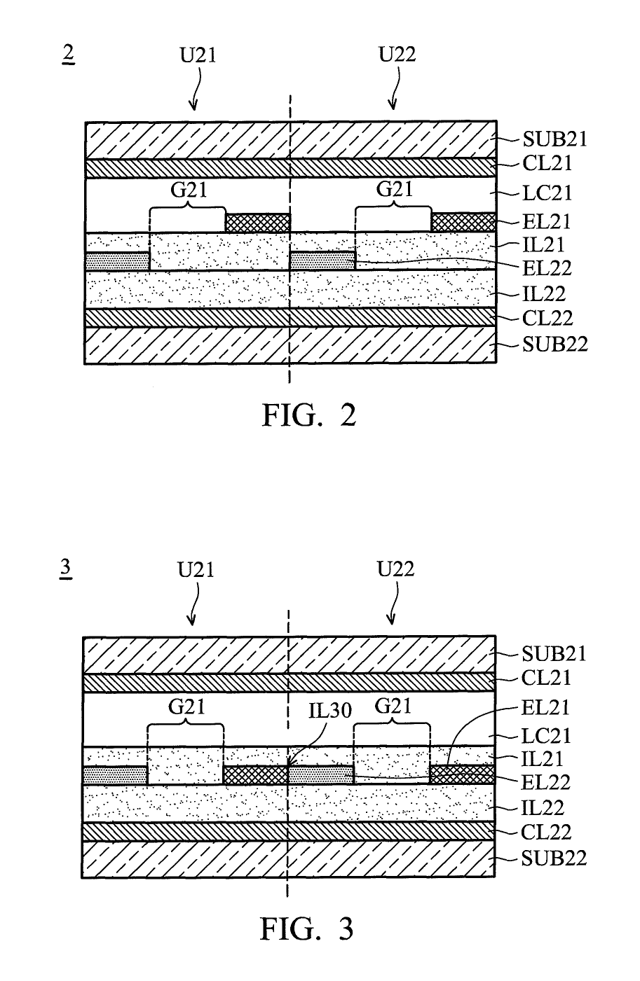

FIG. 2 is a cross section of one exemplary embodiment of a parallax barrier for 3D display. Referring to FIG. 2, a parallax barrier 2 comprises a plurality of barrier cells which are disposed successively. For clear description, FIG. 2 shows only two barrier cells U21˜U22. In the following, the barrier cell U21 is given as an example for describing a structure of a barrier cell. The other barrier cells have the same structure of the barrier cell U21. As shown in FIG. 2, the parallax barrier U21 comprises substrates SUB21 and SUB22, conductive layers CL21 and CL22, electrode layers EL21 and EL22, insulation layers IL21 and IL22, and a liquid crystal LC21.

The substrate SUB21 is disposed in the upper position of FIG. 2, while the substrate SUB 22 is disposed in the lower position of FIG. 2 which is opposite to the position of the substrate SUB21. The liquid crystal LC21 is disposed between the substrates SUB21 and SUB22. The conductive layer CL21 is disposed on the substrate SUB21 and between the liquid crystal layer LC21 and the substrate SUB21. The conductive layer CL22 is disposed on the substrate SUB22 and between the liquid crystal layer LC22 and the substrate SUB21. The insulation layers IL22 and IL21 are disposed on the conductive layer CL22 in order. In detail, the insulation layer IL21 is disposed on the insulation layer IL22, and between the liquid crystal layer LC21 and the insulation layer IL22. The insulation layer IL21 is adjacent to the liquid crystal layer LC21.

Referring to FIG. 2, the electrode layer EL22 is embedded in the insulation layer IL21, and the electrode layer EL21 is disposed on the insulation layer IL21. The electrodes EL21 and EL22 are disposed alternately. Due to the disposition of the insulation layers IL21 and IL22, the electrode layers EL21 and EL22 are electrically isolated from the conductive layer CL22. According to the embodiment of FIG. 2, the electrode layers EL21 and EL22 are disposed on different planes. Moreover, there is a gap G21 between the electrode layers EL21 and EL22.

The conductive layer CL21 receives a common voltage signal VCOM, the conductive layer CL22 receives a voltage signal VS1, the electrode layer EL21 receives a voltage signal VS2, and the electrode layer EL22 receives a voltage signal VS3. In the embodiment, the parallax barrier 2 operates in a normally white mode. The voltage difference between the common voltage signal VCOM of the conductive layer CL21 and the voltage signal VS1 of the conductive layer CL22 is referred to as a dark voltage, and an electric field is formed between the conductive layers CL21 and CL22 according to the dark voltage. When a level of one of the voltage signals VS2 and VS3 is equal to a level of the common voltage signal, the corresponding electrode layer shields the electric field between the conductive layers CL21 and CL22. The position of the one electrode layer in the parallax barrier 2 serves as a transparent area. At the same time, a level of the other of the voltage signals VS2 and VS3 is not equal to the level of the common voltage signal VCOM (for example, the level of the other voltage signal is equal to a level of the voltage signal VS1), and the position of the other electrode layer in the parallax barrier 2 serves as an opaque area. Accordingly, by controlling the levels of the voltage signals VS2 and VS3, the electrode layers EL21 and EL22 serve as a transparent area or an opaque area alternately, thereby forming an active parallax barrier for displaying 3D images.

Moreover, the parallax barrier 2 may operate in a normally black mode. In this case, the position of the electrode layer, which shields the electric field between the conductive layers CL21 and CL22, in the parallax barrier 2 serves as an opaque area. By controlling the levels of the voltage signals VS2 and VS3, the electrode layers EL21 and EL22 serve as a transparent area or an opaque area alternately, thereby forming an active parallax barrier for displaying 3D images.

In the embodiment, for each barrier cell, due to the existence of the gap G21, the aperture ratio of each of the electrode layers EL21 and EL22 is about 35%˜40% in which visual effect is better for views. In some embodiments, there is no gap between the electrode layers EL21 and EL22.

According to the embodiment of FIG. 2, the electrode layers EL21 and EL22 are disposed on the same substrate SUB22. Thus, during the alignment between the substrates SUB11 and SUB12, an alignment error between the electrode layers EL11 and EL12 is not considered, and image crosstalk is degraded.

FIG. 3 is a cross section of another exemplary embodiment of a parallax barrier for 3D display. In FIGS. 2 and 3, the same element is labeled by the same reference sign. Referring to FIGS. 2 and 3, the difference between the parallax barriers 2 and 3 is that in FIG. 3, the electrode layers EL21 and EL22 are disposed on the same plane. In other words, the electrode layer EL22 is also embedded in the insulation layer IL21, and the electrode layers EL21 and EL22 are disposed alternately. In the parallax barrier 3, there is an insulation layer IL30 between the electrode layer EL21 of one barrier cell and the electrode layer EL22 of one adjacent barrier cell. For example, there is an insulation layer IL30 between the electrode layer EL21 of the barrier cell U21 and the electrode layer EL22 of the adjacent barrier cell U22. In the structure, for each barrier cell, if there is no gap between the electrode layers EL21 and EL22, an insulation layer is disposed between the electrode layers EL21 and EL22. The structure of FIG. 3 is advantageous for increasing the aperture ratio of the barrier and enhancing luminous efficiency of a backlight source.

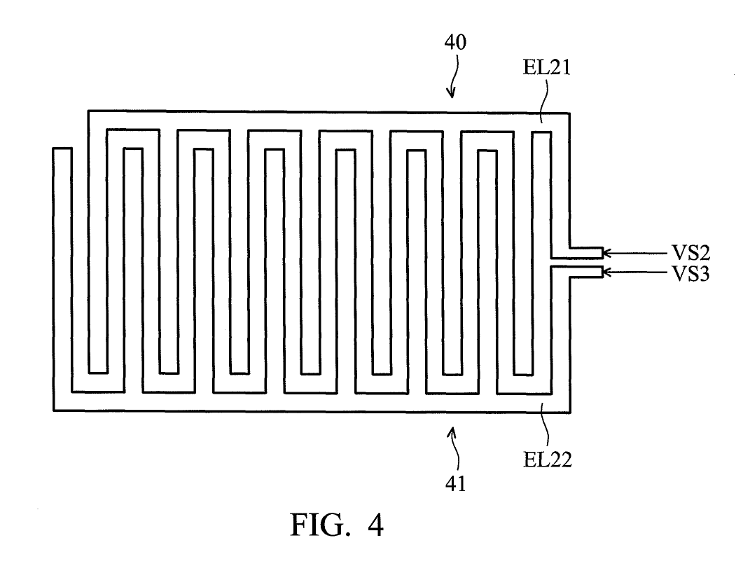

In FIGS. 2 and 3, no matter if the electrode layers EL21 and EL22 are disposed on the same plane or not, as shown in FIG. 4, the electrode layers EL 21 of the plurality of barrier cells form an inter-digital structure 40, and the electrode layers EL 22 of the plurality of barrier cells form an inter-digital structure 41. The inter-digital structures 40 and 41 are disposed oppositely and alternately.

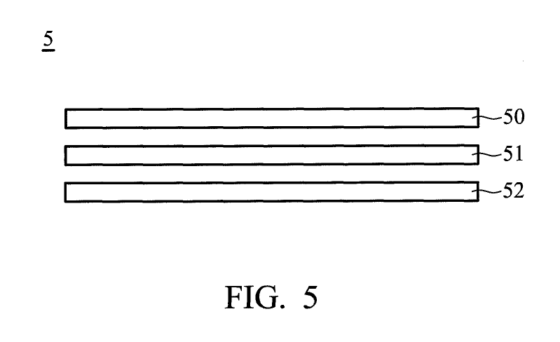

Each of the parallax barriers 2 and 3 may operate in coordination with a display array to form a display device for displaying 3D images. FIG. 5 shows an exemplary embodiment of a display device. Referring to FIG. 5, a display device 5 comprises a parallax 50, a display array 51, and a backlight module 52. In the embodiment of FIG. 5, the parallax barrier 50 is the same as the parallax barrier 2 of FIG. 2 for clear description. In other embodiments, the parallax barrier 50 may be the same as the parallax barrier 3 of FIG. 3. Moreover, FIG. 5 shows the relative position of the parallax 50, the display array 51, and the backlight module 52. In practice, the parallax 50, the display array 51, and the backlight module 52 are stacked tightly, there is another component between the parallax barrier 50 and the display array 51 or between the display array 52 and the backlight module 53, or the display array 51, the parallax barrier 50, and the backlight module 52 are disposed in order. Referring to FIG. 5, the backlight module 52 is disposed on one side of the display array 51 to provide light to the display array 51. The parallax barrier 50 is disposed on the other side of the display array 51.

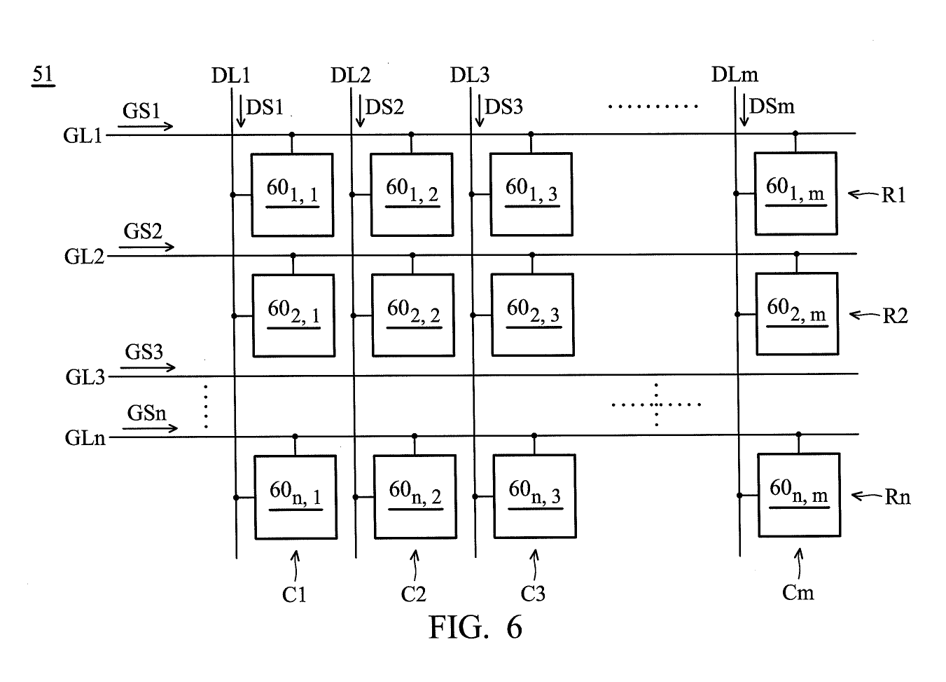

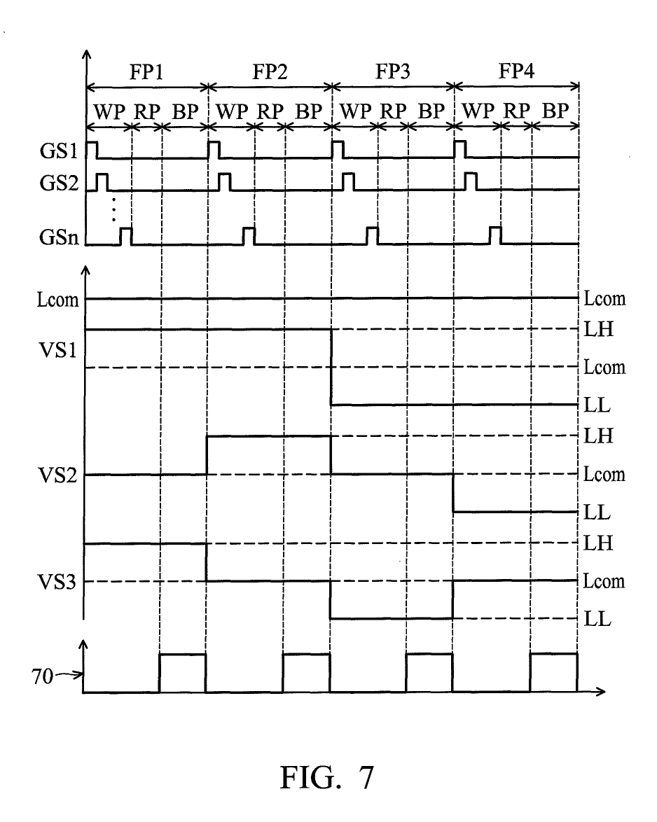

FIG. 6 is a schematic view showing the display array 51. Referring to FIG. 6, the display array 51 comprises a plurality of display cells 60_{1, 1}˜60_{n, m}, a plurality of data lines DL1˜DLm, and a plurality of gate lines GL1˜GLn. The display cells 60_{1, 1}˜60_{n, m}, are disposed in the cross area of columns C1˜Cm and rows R1˜Rn. The data lines DL1˜DLn provide data signal SD1˜DSm respectively. The gate lines GL1˜GLn carry gate lines GS1˜GSn respectively. When a gate signal is asserted, the corresponding gate line is enabled. The data lines DL1˜DLm are interlaced with the gate lines GL1˜GLn. The data lines DL1˜DLm are coupled to the display cells disposed on the columns C1˜Cm respectively, and the gate lines GL1˜GLn are coupled to the display cells disposed on the rows R1˜Rn respectively. Each set of interlaced data line and gate line corresponds to one display cell. For example, the interlaced data line DL1 and the gate line GL1 correspond to the display cell 60_{1, 1}.

FIG. 7 is a timing chart of the main signals of the display device of FIG. 5. Referring to FIG. 7, the label “70” represents the timing when the backlight module 52 is activated and inactivated. The operation of the display device 5 will be described by referring to FIGS. 2, 6, and 7.

The display device 5 displays images during successive frame periods. In FIG. 7, four frame periods FP1˜FP4 are given as an example. Each frame period comprises a writing period WP, a liquid crystal response period RP, and a backlight activated period BP. In the embodiment, each frame period is about 8.33 ms (1/120 s),

Referring to FIGS. 2, 6, and 7, the frame period FP1 is given as an example to describe the operations of the parallax 50, the display array 51, and the backlight module 52. During the other frame periods FP2˜FP4, the display array 51 and the backlight module 52 perform the same operations as the frame period FP1. In the writing period WP, the gate lines GS1˜GSn are asserted successively (that is the gate lines GL1˜GLn are enabled successively) to drive the display cells on the rows R1˜Rn respectively, and the data lines DL1˜DLm provide the data signals DS1˜DSm to the driven display cells on the columns C1˜Cm respectively. After the display cells receive the data signal DS1˜DSm, in the liquid crystal response period RP, the liquid crystal molecules in the display cells rotate according to the received data signal DS1˜DSm. According to FIG. 7, in the writing period WP and the liquid crystal response period RP of the frame period FP1, the backlight module 52 is inactivated and stops providing light to the display array 51. After, the display device 5 enters the backlight activated period BP in which the backlight module 52 is activated to provide light to the display array 51.

Referring to FIGS. 2 and 7, during the frame periods FP1˜FFP4, the level Lcom of the common voltage signal VCOM received by the conductive layer CL21 of the parallax barrier is fixed on a middle level Lcom. During the frame period FP1, the level of the voltage signal VS1 received by the conductive layer CL22 is equal to a high level LH which is larger than the middle level Lcom. At this time, the level of the voltage signal VS3 received by the electrode layer EL22 is the high level LH, and the level of the voltage signal VS2 received by the electrode layer EL21 is equal to the middle level Lcom. As the above description, the level of the voltage signal VS2 and the level of the common signal VCOM are equal to the middle level Lcom, and the level of the voltage signal VS3 and the level of the voltage signal VS1 are equal to the high level LH. Thus, the electrode layer EL21 shields the electric field between the conductive layers CL21 and CL22, so that the position of the electrode layer EL21 in the parallax barrier 50 serves as a transparent area. The position of the electrode layer EL22 in the parallax barrier 502 serves as an opaque area.

During the frame period FP2, the level of the voltage VS1 is still at the high level LH. At this time, the level of the voltage signal VS3 is switched to the middle level Lcom, and the level of the voltage signal VS2 is switched to the high level LH. According to the above description, the level of the voltage signal VS3 and the level of the common voltage signal VCOM are equal to the middle level Lcom, and the level of the voltage signal VS2 and the level of the voltage signal VS1 are equal to the high level LH. Thus, the electrode layer EL22 shields the electric field between the conductive layers CL21 and CL22, so that the position of the electrode layer EL22 in the parallax barrier 50 serves as a transparent area. The position of the electrode layer EL21 in the parallax barrier 502 serves as an opaque area.

In order to prevent the liquid crystal molecules in the liquid crystal layer LC21 from deformation inertia, during the frame period FP3, the level of the voltage signal VS1 is switched to a low level LL which is lower tan the middle signal Lcom. At this time, the level of the voltage signal VS3 is switched to the low level LL, and the level of the voltage signal VS2 is switched to the middle level Lcom. According to the above description, the level of the voltage signal VS2 and the level of the common voltage signal VCOM of the electrode layer EL22 are equal to the middle level Lcom, and the level of the voltage signal VS3 and the level of the voltage signal VS1 are equal to the low level LL. Thus, the electrode layer EL21 shields the electric field between the conductive layers CL21 and CL22, so that the position of the electrode layer EL21 in the parallax barrier 50 serves as a transparent area. The position of the electrode layer EL22 in the parallax barrier 502 serves as an opaque area

During the frame period FP4, the level of the voltage VS1 is still at the low level LL and switched to the high level LH during the next frame period. During the frame period FP4, the level of the voltage signal VS3 is switched to the middle level Lcom, and the level of the voltage signal VS2 is switched to the low level LL. According to the above description, the level of the voltage signal VS3 and the level of the common voltage signal VCOM are equal to the middle level Lcom, and the level of the voltage signal VS2 and the level of the voltage signal VS1 are equal to the low level LL. Thus, the electrode layer EL22 shields the electric field between the conductive layers CL21 and CL22, so that the position of the electrode layer EL22 in the parallax barrier 50 serves as a transparent area. The position of the electrode layer EL21 in the parallax barrier 502 serves as an opaque area.

According to the above description, with the switching of the frame periods, the level of the voltage signal VS2 and the level of the voltage signal VS3 are alternately equal to the level of the common voltage signal VCOM, and the level of the voltage signal VS2 and the level of the voltage signal VS3 are alternately equal to the level of the voltage signal VS1. In detailed, when the level of the voltage signal VS2 is equal to the level of the common voltage signal VCOM, and the level of the voltage signal VS3 is equal to the level of the voltage signal VS1. When the level of the voltage signal VS2 is equal to the level of the voltage signal VS1, and the level of the voltage signal VS3 is equal to the level of the common voltage signal VCOM. Moreover, every two frame periods, the level of the voltage signal VS1 is switch between the high level LH and the low level LL. By controlling the levels of the voltage signals VS2 and VS3, the electrode layers EL21 and EL22 serve as a transparent area alternately. Accordingly. The parallax barrier 50 forms an active parallax barrier. The parallax barrier 50 can operate in coordination with the display array 51 and the backlight module 52 to display 3D images,

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A parallax barrier for 3D display comprising:
a plurality of barrier cells disposed successively, wherein each of the plurality of barrier cells comprises:
a first substrate;
a second substrate disposed opposite to the first substrate;
a liquid crystal layer disposed between the first substrate and the second substrate;
a first conductive layer disposed on the first substrate;
a second conductive layer disposed on the second substrate;
a first insulation layer;
a second insulation layer, wherein the second insulation layer and the first insulation layer are disposed on the second conductive layer in order;
a first electrode layer disposed between the liquid crystal layer and the second insulation layer and electrically isolated from the second conductive layer; and
a second electrode layer disposed between the liquid crystal layer and the second insulation layer and electrically isolated from the second conductive layer.

2. The parallax barrier as claimed in claim 1, wherein the first insulation layer is adjacent to the liquid crystal layer.

3. The parallax barrier as claimed in claim 1, wherein the first electrode layer is disposed on the first insulation layer.

4. The parallax barrier as claimed in claim 3, wherein the second electrode layer is embedded in the first insulation layer.

5. The parallax barrier as claimed in claim 4, wherein the first electrode layer and the second electrode layer are disposed alternately, and there is a gap between the first electrode layer and the second electrode layer.

6. The parallax barrier as claimed in claim 1, wherein the first electrode layer and the second electrode layer are embedded in the first insulation layer.

7. The parallax barrier as claimed in claim 6, wherein each of the plurality of barrier cells comprises:
a third insulation layer disposed between the first electrode layer and the second electrode layer.

8. The parallax barrier as claimed in claim 1, wherein the first electrode layers of the plurality of barrier cells form a first inter-digital structure, the second electrode layers of the plurality of barrier cells form a second inter-digital structure, and the first inter-digital structure and the second inter-digital structure are disposed oppositely and alternately.

9. A driving method for 3D display for driving a parallax barrier as claimed in claim 1, comprises:
providing a common voltage signal to the first conductive layer;
providing a first voltage signal to the second conductive layer;
providing a second voltage signal to the first electrode layer;
providing a third voltage signal to the second electrode layer; and
successively switching a level of the second voltage signal and a level of the third voltage signal to be equal to a level of the common voltage signal.

10. The driving method as claimed in claim 9, wherein the step of successively switching the level of the second voltage signal and the level of the third voltage signal to be equal to the level of the common voltage signal comprises:
switching the level of one of the second voltage signal and the third voltage signal to be equal to the level of the common voltage signal; and
switching the level of the other of the second voltage signal and the third voltage signal to be not equal to the level of the common voltage signal.

11. The driving method as claimed in claim 10, wherein in the step of successively switching the level of the second voltage signal and the level of the third voltage signal to be equal to the level of the common voltage signal, when the level of the second voltage signal is switched to be equal to the level of the common voltage signal, the first electrode layer shields an electric field between the first conductive layer and the second conductive layer, and a position of the first electrode layer in the parallax barrier serves as a transparent area.

12. The driving method as claimed in claim 10, wherein in the step of successively switching the level of the second voltage signal and the level of the third voltage signal to be equal to the level of the common voltage signal, when the level of the second voltage signal is switched to be equal to the level of the common voltage signal, the level of the third voltage signal is switched to not be equal to the level of the common voltage signal, and a position of the second electrode layer in the parallax barrier serves as an opaque area.

13. A display device for 3D display for displaying images during a plurality of successive frame periods, comprising:
a display array;
a backlight module, disposed on one side of the display array; and
a parallax barrier disposed on the other side of the display array, wherein the parallax barrier comprises a plurality of barrier cells disposed successively, and each of the plurality of barrier cells comprises:
a first substrate;
a second substrate disposed opposite to the first substrate;
a liquid crystal layer disposed between the first substrate and the second substrate;
a first conductive layer disposed on the first substrate and receiving a common voltage signal;
a second conductive layer disposed on the second substrate and receiving a first voltage signal;
a first electrode layer disposed between the liquid crystal layer and the second conductive layer and electrically isolated from the second conductive layer, wherein the first electrode layer receives a second voltage signal; and
a second electrode layer disposed between the liquid crystal layer and the second conductive layer and electrically isolated from the second conductive layer, wherein the second electrode layer receives a third voltage signal,
wherein with the plurality of successive frame periods, a level of the second voltage signal and a level of the third voltage signal are equal to a level of the common voltage signal successively.

14. The display device as claimed in claim 13, wherein for each of the plurality of barrier cells, the first electrode layer and the second electrode layer are disposed alternately.

15. The display device as claimed in claim 13, wherein each of the plurality of barrier cells comprises:
a first insulation layer disposed between the liquid crystal layer and the second conductive layer,
wherein the first electrode layer is disposed on the first insulation layer, and the second electrode layer is embedded in the first insulation layer.

16. The display device as claimed in claim 15, wherein each of the plurality of barrier cells comprises:
a second insulation layer disposed between the first insulation layer and the second conductive layer.

17. The display device as claimed in claim 13, wherein each of the plurality of barrier cells comprises:
a first insulation layer disposed between the liquid crystal layer and the second conductive layer,
wherein the first electrode and the second electrode layer are embedded in the first insulation layer.

18. The display device as claimed in claim 17, wherein each of the plurality of barrier cells comprises:
a second insulation layer disposed between the first insulation layer and the second conductive layer.

19. The display device as claimed in claim 13, wherein the first electrode layers of the plurality of barrier cells form a first inter-digital structure, the second electrode layers of the plurality of barrier cells form a second inter-digital structure, and the first inter-digital structure and the second inter-digital structure are disposed oppositely and alternately.

20. The display device as claimed in claim 13, during each of the plurality of frame periods, wherein when the level of one of the second voltage signal and the third voltage signal is equal to the level of the common voltage signal, the level of the other of the second voltage signal and the third voltage signal is not equal to the level of the common voltage signal.

21. The display device as claimed in claim 13, wherein according to the second voltage signal and the third voltage signal, the first electrode layer and the second electrode layer shield an electric field between the first conductive layer and the second conductive layer successively.

22. The display device as claimed in claim 21,
wherein when the level of the second voltage signal is equal to the level of the common voltage signal, the first electrode layer shields the electric field between the first conductive layer and the second conductive layer, and a position of the first electrode layer in the parallax barrier serves as a transparent area, and
wherein when the level of the third voltage signal is equal to the level of the common voltage signal, the second electrode layer shields the electric field between the first conductive layer and the second conductive layer, and a position of the second electrode layer in the parallax barrier serves as the transparent area.

23. The display device as claimed in claim 13, wherein the display array comprises:
a plurality of display cells disposed in a plurality of columns and a plurality of rows;
a plurality of data lines; and
a plurality of gate lines interlaced with the plurality of data lines, wherein each of the plurality of gate lines is coupled to the display cells in one row,
wherein in a writing period of each of the plurality of frame periods, the gate lines are enabled successively to drive the plurality of display cells, and the data lines provide a plurality of data signals to the plurality of display cells, and
wherein during each of the plurality of frame periods, the backlight module is inactivated and stops providing light in the writing period, and the backlight module is activated to provide light after the writing period.
